(19) United States
(12) Patent Application Publication
(10) Pub. No.: US 2009/0131593 A1
(43) Pub. Date: May 21, 2009

(54) Polyethylene films for packaging

(75) Inventor: Gianni Perdomi, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l, Milan (IT)

(21) Appl. No.: 10/556,558

(22) PCT Filed: May 18, 2004
(86) PCT No.: PCT/EP04/05353

§ 371 Date: Nov. 14, 2005

Related U.S. Application Data
(60) Provisional application No. 60/474,420, filed on May 30, 2003.

(30) Foreign Application Priority Data
May 21, 2003 (EP) 03011532.3

(51) Int. Cl. C08L 23/08

(52) U.S. Cl. 525/227

(57) ABSTRACT

An elastic film comprising a polymer blend comprising (percent by weight): 1) 50 to 80% of an ethylene polymer t composition comprising a recurring unit derived from an ester selected from (1) ethylenically unsaturated organic monomer of esters of unsaturated C₃-C₂₀ monocarboxylic acids and C₁, to C₂₄ monovalent aliphatic or alicyclic alcohols, and (2) vinyl esters of saturated C₂-C₁₈ carboxylic acids, wherein the ester content ranging from 2.5 to 8 wt % based on the total weight of the final ethylene polymer composition; the ethylene polymer composition having a density ranging from 0.920 to 0.935 g/mL; and II) 20 to 50% of an ethylene-based polymer component having a density ranging from 0.9 to 0.930 g/mL and a melt flow rate up to 4 g/10 min. The film that has a ratio between the MD Elmendorf tear resistance and TD Elmendorf tear resistance of 0.3 or less is suitable for pallet application as banding tape.

The present invention relates to elastic films and in particular elastic banding tapes suitable for packaging. More particularly, it relates to films and banding tapes made from polyolefin materials comprising a blend of low density ethylene copolymers and minor amounts of linear polyethylene.

There are many items of commerce that are bundled together for shipment and sale, Typically bottles, cans, glassware and any other palletized staked item are but a few of such items. Banding tapes must remain secure during shipment and handling so they can provide the sufficient pallet stability.

One way to band or bundle items is by using polypropylene or polyester strapping tapes. However, the narrow width of the strap exhibits certain drawbacks. The strap can be unsuitable to consolidate items into palletized units in the case of small items because the strap does not involve every item.

Another drawback caused by the narrow width of straps is the very narrow room where to print trademarks and other pieces of information. This is a very serious drawback for marketing purpose.

The Applicant has now discovered an elastic film and an elastic banding tape comprising an elastic polyolefin composition that exhibits excellent sealing and dynamic properties such as good elastic properties, flexibility, high residual strength and a desired balance between tensile strength and residual strength.

The banding tape of the present invention has the advantage that can be produced with any width. It means that the tape of the present invention does not have the above-mentioned drawbacks that are typically of the straps.

The film and tape of the present invention advantageously have also quite good optical properties.

Therefore, the present invention provides an elastic film or an elastic banding tape comprising a polymer blend (A) comprising (percent by weight):
I) 50 to 80%, preferably higher than 50 to 75, more preferably 60 to 70%, of an ethylene polymer composition comprising a recurring unit derived from an ester selected from (1) ethylenically unsaturated organic monomer of esters of unsaturated C₃-C₂₀ monocarboxylic acids and C₁ to C₂₄ monovalent aliphatic or alicyclic alcohols, and (2) vinyl esters of saturated C₂-C₁₈ carboxylic acids, wherein the ester content ranging from 2.5 to 8 wt %, preferably 3 to 6.5 wt %, based on the total weight of the final ethylene polymer composition; the ethylene polymer composition having a density ranging from 0.920 to 0.935 g/mL; and
II) 20 to 50%, preferably 25 to less than 50, more preferably 30-40%, of an ethylene-based polymer component having a density ranging from 0.9 to 0.930 g/mL, preferably 0.910 to 0.925 g/mL, and a melt flow rate up to 4 g/10 min, preferably from 0.5 to 2 g/10 min; the said component being selected from:
   i) a linear polyethylene (i) consisting of ethylene and 0.5 to 20% by mole of a CH₂═CHR α-olefin, where R is a hydrocarbon radical having 2-8 carbon atoms; and
   ii) a polymer blend (ii) comprising (a) 80-100 parts by weight of a random interpolymer of ethylene with at least one CH₂═CHR α-olefins, where R is a hydrocarbon radical having 1-10 carbon atoms, the said polymer containing up to 20 mol % of CH₂═CHR α-olefin and having a density between 0.88 and 0.945 g/mL; and (b) from 5 to 30 parts by weight of a random interpolymer of propylene with at least one CH₂═CHR α-olefin, where R is a hydrocarbon radical having from 2 to 10 carbon atoms, and optionally ethylene, said interpolymer (b) containing from 60 to 98% by weight of units derived from propylene, from 2 to 40% by weight of recurring units derived from the CH₂═CHR α-olefin, and from 0 to 10% by weight of recurring units derived from ethylene, and having a xylene-insoluble fraction a room temperature greater than 70%.

The film or tape according to the present invention has a ratio between the MD Elmendorf tear resistance and TD Elmendorf tear resistance of 0.3 or less. The Elmendorf tear resistance is determined according to the method as described hereinbelow.

Preferably the film (hereinafter the word film also implies the word tape) according to the present invention exhibits a value of 2% secant MD tensile modulus equal to or lower than 130 MPa.

Typically, the film according to the present invention has a ratio between the value of MD residual strength at 30% and MD tensile stress at 30% of 0.5.

The film advantageously has a value of MD normalised residual strength at 30% ranging from 7 to 11 cN/μm, preferably from 7.5 to 11 cN/μm. The said mechanical properties are determined as explained hereinbelow.

As used herein, the phrase “normalised residual strength” is the residual strength divided by the thickness of the film/strip.

The abbreviation “MD” means “machine direction”, and refers to a direction “along the length” of the film, i.e., in the direction of the film as the film is formed during extrusion and/or coating; the abbreviation “TD” means “transverse direction”, and refers to a direction across the film, perpendicular to the machine or longitudinal direction.

Preferably, ethylene polymer composition (1) is an interpolymer of ethylene with at least one comonomer selected from above-mentioned esters (1) and (2), wherein the comonomer content is within the 2-8 wt % range. The term “interpolymer” as used herein refers to polymers prepared by the polymerization of at least two different types of monomers. The generic term “interpolymer” thus includes the term “copolymers” (which is usually employed to refer to polymers prepared from two different monomers) as well as the term “terpolymers” (which is usually employed to refer to polymers prepared from three different types of monomers, e.g., an ethylene/butene/hexene polymer).

Alternatively, ethylene polymer composition (I) can be a blend comprising (a) an ethylene homopolymer or interpolymer of ethylene with at least one of above-mentioned esters (1) and (2) wherein the esters content is in an amount from 2 to less than 8 wt % and (b) an interpolymer of ethylene with at least one of above-mentioned esters (1) and (2). In interpolymer (b) the content of the ester(s) can be higher than 8 wt %, provided that in the blend the ester content is in the range from 2 to 8 wt %.

In said blend ethylene homopolymer (a) is preferably a low density ethylene homopolymer (which is known as LDPE), which typically has melt flow rate ranging from 0.1 to 20 g/10 min and a density value of 0.015-0.932 g/mL. LDPE is produced according to known polymerisation method with a free radical initiator, such as peroxide and oxygen. It is generally produced by either a tubular or a stirred autoclave reactor.

In such a blend ethylene interpolymer (b) can have a density value higher than 0.940 g/mL.

As specific examples of the comonomers copolymerized with the ethylene monomer to produce ethylene polymer composition (1), there can be mentioned unsaturated carboxylic acid esters represented by acrylates and methacrylates, which include acrylates and methacrylates having a linear or branched alkyl group with 1 to about 24 carbon atoms, such as methyl acrylate, ethyl acrylate, propyl acrylate, butyl acrylate, t-butyl acrylate, isobutyl acrylate, pentyl acrylate, isononyl acrylate, hexyl acrylate, 2-methylpentyl acrylate, octyl acrylate, 2-ethylhexyl acrylate, dodecyl acrylate, methyl methacrylate and ethyl methacrylate; lauryl (meth)acrylate and cyclohexyl (meth)acrylate.

In branched ethylene polymer composition (1) having low density preferred comonomers which can be copolymerized with ethylene include methyl acrylate (EMA copolymers), ethyl acrylate (EEA copolymers), butyl acrylate (EBA copolymers) and vinyl acetate (EVA copolymers). EBA copolymers and EVA copolymers are the most preferred copolymers.

Ethylene polymers (II) are inclusive of diverse groups of ethylene polymers having low density. More specifically, the term “linear polyethylene” used herein encompasses both heterogeneous materials as linear low density polyethylene (LLDPE), very low and ultra low density polyethylene (VLDPE and ULDPE) as well as homogeneous polymers. Said homogenous polymers also known as plastomers are thermoplastic homopolymers of ethylene and interpolymers of ethylene, with one or more α-olefins having 2-10 C-atoms, which are to be prepared by means of metallocene catalysts and other single-site catalysts. As a rule, the proportion of comonomer ranges between 0 and 50 wt. %, preferably between 5 and 35 wt. %. Said homogeneous polymers usually has a density between 0.90-0.930 g/mL and a melt flow rate value of 0.8-2.0 g/10 min at 2.16 kg loading and 190° C. The homogeneous polymers are different from the polyethylenes prepared by means of Ziegler-Natta catalysts, for example, in that they have a narrow molecular weight distribution, which in terms of M̅_{w}/ M̅ₙ values usually ranges between 1.5 and 3, and a limited degree of long chain branching. As a rule, the number of long chains amounts to maximally 3 per 1000 C-atoms.

Suitable homogeneous polymers are produced on a commercial scale, for example by Exxon Chemical Company and DEX-Plastomers under the brand name Exact and by Dow Chemical Company, which commercializes them with the trademark Engage, Affinity and Elite, and by Mitsui Petrochemical Corporation, which commercialized them with the trademark Tafiner.

In ethylene polymer composition (I) the ester content is typically 3 to less than 5 wt % when ethylene-based polymer component (II) is a homogeneous polymer.

The low density of the linear polyethylene is obtained by copolymerizing ethylene with the above CH₂═CHR α-olefins where R is a linear or branched hydrocarbon radical with from 2 to 8 carbon atoms; the olefin is preferably selected from 1-butene, 1-hexene, 1-octene and 4-methyl-1-pentene. The most preferable comonomers in the ethylene copolymer are 1-butene, 1-hexene and 1-octene.

Linear polyethylene (II) used in the present invention is prepared according to known ways of polymerization involving the use of coordination catalysts of the “Ziegler-Natta” or “Philips” type. For example, it is prepared by copolymerization of ethylene with a C₄-C₁₀-α-olefin in the presence of a Ziegler-Natta type catalyst obtained by the reaction of an organometallic compound of a metal from groups 2 and 3 of the Periodic Table with a catalytic component comprising a transition metal belonging to groups 4 to 6 of the Periodic Table. Preferably the transition metal compound is supported on a solid carrier comprising magnesium halide in active form. Examples of catalysts usable in the preparation of the copolymer are described in U.S. Pat. Nos. 4,218,339 and 4,472,520. The catalyst may also be prepared according to the methods described in the U.S. Pat. Nos. 4,748,221 and 4,803,251. Particularly preferred are the catalysts comprising components having regular morphology, for example spherical. Examples of such catalysts are described in the European patent applications 395083, 553805 and 553806.

The above polymer blend (ii) is described in international patent application WO 95/20009. The propylene interpolymer in blend (ii) may be, for example, a copolymer of propylene with ethylene or a copolymer of propylene with butene-1. It is preferably a terpolymer of propylene with ethylene and a C₄-C₁₀-α-olefin. In such a case, the propylene content is from 85 to 96 wt %, the ethylene content is from 2 to 8 wt % and the C₄-C₁₀-α-olefin content is from 2 to 7 wt %.

In polymer blend (ii) component (a) is preferably a copolymer of ethylene with 1-butene and component (b) is a terpolymer of propylene with ethylene and 1-butene.

The high insolubility in xylene of the propylene interpolymer (b) is indicative of a stereoregular structure of the propylene recurring units and of homogenous distribution of the comonomer(s) in the interpolymer chain. The insolubility in xylene, determined as described hereinbelow, is preferably greater than 75 wt %, more preferably greater than 85 wt %.

The heat of fusion of the propylene interpolymer (b) is generally greater than 50 J/g, preferably greater than 60 J/g, more preferably greater than 70 J/g.

The melting temperature of the propylene interpolymer (b) is below 140° C. and preferably from 120° to 140° C.

The crystalline index of the propylene interpolymer (b) is generally greater than 50%.

The MFR value, which is determined as described hereinbelow, of the propylene interpolymer (b) is generally from 2 to 30 g/10 min.

The propylene interpolymer (b) can conveniently be prepared using a highly stereospecific catalyst, for example, of the type described in patent application EP 395 083.

Polymer blend (ii) can be obtained by firstly blending the components (a) and (b) in the solid state and then being fed into the extruder wherein the two components are mixed in the molten state, for example in a mixer with high mixing efficiency.

According to a preferred method, polymer blend (ii) is prepared directly by polymerization process in at least two reactors in series which, working in any order and using the same catalyst in the various reactors, ethylene polymer (a) is prepared in one reactor and the propylene polymer (b) is produced in the other. The polymerization is conveniently carried out in the gas phase using fluidized-bed reactors. Examples of polymers prepared according to the said method are described in patent applications WO 93/03078 and WO 95/20009. A suitable catalyst is obtained from the reaction of:
A) a solid catalytic component comprising a titanium component containing at least a titanium halogen bond supported on a magnesium halide in active form and, optionally an electron-donor compound;
B) an Al-alkyl compound; and, optionally,
C) an electron-donor compound.

The polymer blend (A) according to the present invention is formed by any convenient method, including dry blending the individual components and subsequently melt-mixing, either directly in the extruder used to make the film/strip, or by pre-melt mixing in separate extruder before making the film/strip.

Obviously, in accordance with what is known by a person skilled in the art, further additives (such as stabilizers, antioxidant, antiblocking, slip agents, colours, etc.) and fillers than are capable of imparting specific properties to the film/strip of the present invention may be added to the polymer blend (A).

The film of elastic material can be made using any of the several methods of film forming known in the art such as, extrusion, coextrusion, blowing and cast and the like.

The film of the present invention may be monolayer or multilayer. However, for coextruded multilayer structures (e.g., 3-layer strip structures) at least one skin layer should be made from the polymer blend (A) described herein, of course it can also be used as a core layer of the structure. Generally, the polymer blend described herein comprises at least 60 wt % of the total multilayer structure. Preferably, the polymer blend disclosed herein is used as the core layer. In such a film, the skin layers can comprise other polyethylene types from high to low density as well as polypropylene types, or blends of them, in order to impart particular properties at inner or outer face of the film.

A particular aspect of this invention can involve multilayer film where each layer of film consists of the same claimed polymer composition which, however, contain different additives, stabilizers, filler.

The thickness of the film must also be considered as it relates to the recovery force exerted by the material upon being stretched. The recovery force is the force exerted by an elongated strip of material to return to its natural state. The thickness of the film of the present invention may, therefore, vary widely but typical thickness ranges are from about 0.025 mm to about 0.1 mm, preferably from about 0.040 mm to about 0.070 mm. A thinner film is preferred for cost reasons, but it must be thick enough to provide adequate tensile strength for a particular application and processing method. For the three layer structures same final thickness and weight are useful, but each layer distribution may vary from 5 to 50% of the total film thickness, and a number of layers are minimum 2 to 7, preferably 3 to 5.

The film according to the present invention can be printable after corona treatment.

Typically the film has a weight of from 20 to 90 g/m².

The following examples are given to illustrate and not to limit the present invention.

The data relating to the polymer blends and the strips of the examples are determined by way of the methods reported below.
MFR: Measured according to ISO method 1133 (190° C., 2.16 kg).
Density: Measured according to ASTM method D-792.
Comonomer content: Determined by IR spectroscopy.
Fractions soluble and insoluble in xylene at 25° C., 2.5 g of polymer are dissolved in 250 ml of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble and insoluble at room temperature (25° C.).
Tear resistance: Measured using an Elmendorf tear tester according to ASTM method D 1922, determined both in machine direction and transversal direction.
2% secant tensile modulus: Determined according to ASTM method D 822.
Tensile strength and residual strength: Determined according the MA 17301 internal method available upon request. The test is carried out on a film specimen cut from a film.
The film has previously been kept at 23° C., 50% is the relative humidity, for at least 24 hours but not over 48-hours.
The film specimen is placed in an Instron-type dynamometer working at a tensile rate of 50 mm/min. The film is stressed up to a deformation of 30%. The strength is measured when the deformation of 30% is reached (maximum strength) and after 240 minutes from the deformation of 30% is reached (strength 240). The residual strength ratio is defined as the ratio between residual strength 240 and maximum strength.
Dart: Determined according to ASTM method D 1709A.
Haze: Determined according to ASTM method D 1003.
Banding test: the tapes prepared as described in the examples are used to palletizing a regular shaped testing frame. The frame size is 1200×800×1220 mm. The banding test is carried out by using a Roboband 2VH machine that also seals the two endings of the tapes.
The evaluated properties are resistance of the sealed tapes portion and banding step on pallet.
The quality of sealing is determined by evaluating resistance at yielding or breakage of sealed tapes portion immediately after the sealing.
The quality of banding step is determined by evaluating toughness of tapes around the frame.
   Polymers used in the example and comparative example
Ethylene-butyl acrylate copolymer, EBA copolymer: the content of recurring units derived from butyl acrylate is 6.5 wt %, the MFR value is 0.25 g/10 min and the density is 0.923 g/in L;
Low density ethylene homopolymer, LDPE: the MFR value is 0.3 g/10 min and the density is 0.923 g/mL;
Very low density ethylene-octene-1 copolymer, VLDPE: the content of recurring units derived from octene-1 is 15.3 wt % (4.3 mol %), MFR is 1 g/10 min and the density is 0.912 g/mL.

### EXAMPLE 1 AND COMPARATIVE EXAMPLE 1

A polymer blend is produced by extruding the proper components in a single screw type extruder (30 L/D screw length). Table 1 lists the polymers used and their relative amounts.

Then, the thus obtained polymer blends are extruded trough a 40 mm grooved feed single screw extruder (KRC40), thus a tape is produced.

The physical and mechanical properties of the films as well as the results of the banding test carried out on the tape are reported in Table 2.

In comparison with the tape of the comparative example the tape according to the present invention exhibits both a good balance of mechanical properties, good transparency and good sealability. Resistance of the sealed tape is an indirect index of the sealability of the tape. The banding test shows that the tape according to the present invention only have those main properties that make a tape suitable for banding.

TABLE 1

| Components (wt %) | Example 1 | Comparative Example 1 |
|---|---|---|
| EBA copolymer | 67 | 0 |
| LDPE | 0 | 100 |
| VLDPE | 33 | 0 |

TABLE 2

| | | Example | Comparative |
|---|---|---|---|
| Properties of the tape | | 1 | Example 1 |
| Average thickness, mm | | 0.065 | 0.085 |
| 2% secant tensile modulus, MPa | MD | 110 | 188 |
| | TD | 117 | 199 |

| MD tensile strength at 30%¹⁾, N | | 11 | 13 |
|---|---|---|---|
| MD residual strength at 30%, N | | 6 | 5.9 |
| MD residual strength at 30%/MD tensile | | 0.545 | 0.454 |
| strength at 30% ratio | | | |
| MD normalized residual strength at 30%, | | 9.2 | 6.9 |
| cN/μm | | | |
| MD Elmendorf tear resistance, N | | 1.98 | 2.80 |
| MD/TD Elmendorf tear resistance ratio | | 0.174 | 0.228 |
| Dart, g | | 570 | 162 |
| Haze, % | | 17 | 17 |
| Banding test | Resistance of sealing | excellent | poor |
| | tape portion | | |
| | Banding step on pallet | good | poor |

¹⁾Force required to cause the stretching of 30% of a specimen of material.

1-6. (canceled)

7) An elastic film comprising a polymer blend (A) comprising:
(I) 50 to 80% by weight of an ethylene polymer composition comprising a recurring unit derived from an ester selected from (1) ethylenically unsaturated organic monomer of esters of unsaturated C₃-C₂₀ monocarboxylic acids and C₁ to C₂₄ monovalent aliphatic or alicyclic alcohols, and (2) vinyl esters of saturated C₂-C₁₈ carboxylic acids, wherein the ester ranges from 2.5 to 8% by weight based on a total weight of the ethylene polymer composition; the ethylene polymer composition having a density ranging from 0.920 to 0.935 g/mL; and
(II) 20 to 50% of an ethylene-based polymer component having a density ranging from 0.9 to 0.930 g/mL and a melt flow rate up to 4 g/10 min; the ethylene-based polymer component is selected from:
(i) a linear polyethylene (i) consisting of ethylene and 0.5 to 20% by mole of a CH₂═CHR α-olefin, where R is a hydrocarbon radical having 2-8 carbon atoms; and
(ii) a polymer blend (ii) comprising (a) 80-100 parts by weight of a random interpolymer of ethylene with at least one CH₂═CHR α-olefin, wherein R is a hydrocarbon radical having 1-10 carbon atoms, the polymer blend comprising up to 20 mol % of a CH₂═CHR α-olefin and the polymer blend having a density between 0.88 and 0.945 g/mL; and (b) from 5 to 30 parts by weight of a random interpolymer of propylene with at least one CH₂═CHR α-olefin, wherein R is a hydrocarbon radical having from 2 to 10 carbon atoms; the interpolymer of propylene comprising from 60 to 98% by weight of units derived from propylene, from 2 to 40% by weight of recurring units derived from a CH₂═CHR α-olefin, wherein R is a hydrocarbon having from 1-10 carbon atoms, and from 0 to 10% by weight of recurring units derived from ethylene; and the polymer blend having a xylene-insoluble fraction at room temperature greater than 70%;
the film having a ratio between a MD Elmendorf tear resistance and a TD Elmendorf tear resistance of 0.3 or less.

8) The elastic film of claim 7, wherein the ethylene polymer composition is an ethylene-butyl acrylate copolymer or ethylene-vinyl acetate copolymer.

9) The elastic film of claim 7, wherein the ethylene polymer composition further comprises a comonomer selected from butene-1, hexene-1, octene-1, and 4-methyl-1-pentene.

10) The elastic film of claim 7, wherein the random interpolymer of ethylene is an ethylene-butene-1 copolymer.

11) The elastic film of claim 7, wherein the random interpolymer of propylene is a propylene-ethylene-butene-1 terpolymer.

12) An elastic banding tape comprising the elastic film of claim 7.
